(19) United States
(12) Patent Application Publication
(10) Pub. No.: US 2016/0247097 A1
(43) Pub. Date: Aug. 25, 2016

(54) RESERVATION SYSTEM

(71) Applicant: Fly Victor Ltd., London (GB)

(72) Inventors: Clive JACKSON, Berkshire (GB); lain LEWIS, Reading (GB)

(21) Appl. No.: 15/144,586

(22) Filed: May 2, 2016

Related U.S. Application Data
(63) Continuation of application No. 13/775,835, filed on Feb. 25, 2013.
(60) Provisional application No. 61/602,699, filed on Feb. 24, 2012.

(51) Int. Cl. G06Q 10/02; G06Q 50/14

(52) U.S. Cl. CPC G06Q 10/02; G06Q 50/14

(57) ABSTRACT

A computerized system for registering participants for a service provided in a plurality of events for which a variable number of participants may be registered and where at least a part of the costs of the event are fixed. The system receives registration data providing a first and a second number of participants to be registered for the event. The system registers the participants for the event and conducts at least two transactions. The first debiting a first account for, at least, the fixed costs; the second crediting the first account by a further amount in dependence on the registration of said second number of participants for the event.

### CROSS-REFERENCE TO RELATED APPLICATIONS

This application is a continuation of U.S. patent application Ser. No. 13/775,835, filed on Feb. 25, 2013, which claims the benefit of U.S. Provisional Patent Application No. 61/602,699, filed on Feb. 24, 2012. Each of the above-referenced patent applications is incorporated herein by reference in its entirety.

### BACKGROUND OF THE INVENTION

1. Field of the Invention

Embodiments described herein relate to a computerized system for handling reservations for a service, and in particular reservations for a service for which a varying number of participants may register.

2. Description of the Related Technology

Some services may be provided in the form of events, which may be reserved by a single participant, or by a group of participants together. Typically, at least a part of the cost of an event will be fixed; that is, this part of the cost is independent of the number of participants. A further part of the cost of the event may be variable, varying with the number of participants.

In one example, such a service may be a private air charter service. In this example the event comprises a chartered flight, while the fixed costs may include the hire of the plane, the pilot's salary, and the fuel. The variable costs may be limited to the provision of food and drink in flight and any customs charges or taxes. As such, the fixed costs are substantially higher than the variable costs. In some cases, the total cost may be fixed, irrespective of the number of participants.

This high fixed cost makes some services, such as private air charters, expensive. It also means that such services are often underutilized as the high fixed costs are dissuasive to potential participants. As such, while private air charters provide many benefits such as increased comfort, ease of travel etc. these benefit come at a high cost.

There is therefore a need for methods and systems which facilitate the reserving of services, and in particular for methods and systems which enable the costs of such services to be reduced.

### SUMMARY

In accordance with at least one embodiment, methods, devices, systems and software are provided for supporting or implementing functionality to handle reservations for a service.

This is achieved by a combination of features recited in each independent claim. Accordingly, dependent claims prescribe further detailed implementations of various embodiments.

According to an exemplary embodiment, there is provided a computerized system for registering participants for a service, the service being provided in a plurality of events, wherein a variable number of participants are registerable with each event, and wherein at least a first part of a cost of each event is independent of the number of registered participants associated with that event, wherein, the computerized system is configured with a plurality of accounts to enable, at least, registering of, and payment for, participants in events, and wherein the computerized system comprises at least one processing system and at least one memory, wherein the at least one memory comprises computer readable instructions which, when executed by the at least one processing system, cause the computerized system to perform a method comprising: receiving registration data comprising, at least, one or more parameters of an event, data indicative of a first number of participants to be registered for the event in association with a first account, and data indicative of a second number of participants to be registered for the event in association with at least one second account; registering participants for the event based on the first number; conducting a first transaction in which the first account is debited a first amount including, at least, the first part of the cost of the event; registering participants for the event based on the second number; conducting a second transaction in which the at least one second account is debited a second amount; and crediting the first account with at least some of the second amount.

According to a further exemplary embodiment, there is provided a computer program product comprising a non-transitory computer-readable storage medium having computer readable instructions stored thereon, the computer readable instructions being executable by a computerized system to cause the computerized system to perform a method for registering participants for a service, the service being provided in a plurality of events, wherein a variable number of participants are registerable with each event, and wherein at least a first part of a cost of each event is independent of the number of registered participants associated with that event, wherein, the computerized system is configured with a plurality of accounts to enable, at least, registering of, and payment for, participants in events, and the method which comprises: receiving registration data comprising, at least, one or more parameters of an event, data indicative of a first number of participants to be registered for the event in association with a first account, and data indicative of a second number of participants to be registered for the event in association with at least one second account; registering participants for the event based on the first number; conducting a first transaction in which the first account is debited a first amount including, at least, the first part of the cost of the event; registering participants for the event based on the second number; conducting a second transaction in which the at least one second account is debited a second amount; and crediting the first account with at least some of the second amount.

Further features and advantages will become apparent from the following description of preferred embodiments, given by way of example only, which is made with reference to the accompanying drawings.

### BRIEF DESCRIPTION OF THE DRAWINGS

Systems, apparatuses and methods will now be described as embodiments, by way of example only, with reference to the accompanying figures in which:

FIG. 1 shows a schematic diagram of a system in which embodiments may be practiced;

FIG. 2 illustrates a method according to an embodiment;

FIG. 3 shows a schematic diagram of a further system in which embodiments may be practiced; and

FIGS. 4A and 4B illustrate methods according to embodiments.

Some parts, components and/or steps of the embodiments appear in more than one Figure; for the sake of clarity the same reference numeral will be used to refer to the same part, component or step in all of the Figures.

### DETAILED DESCRIPTION OF CERTAIN INVENTIVE EMBODIMENTS

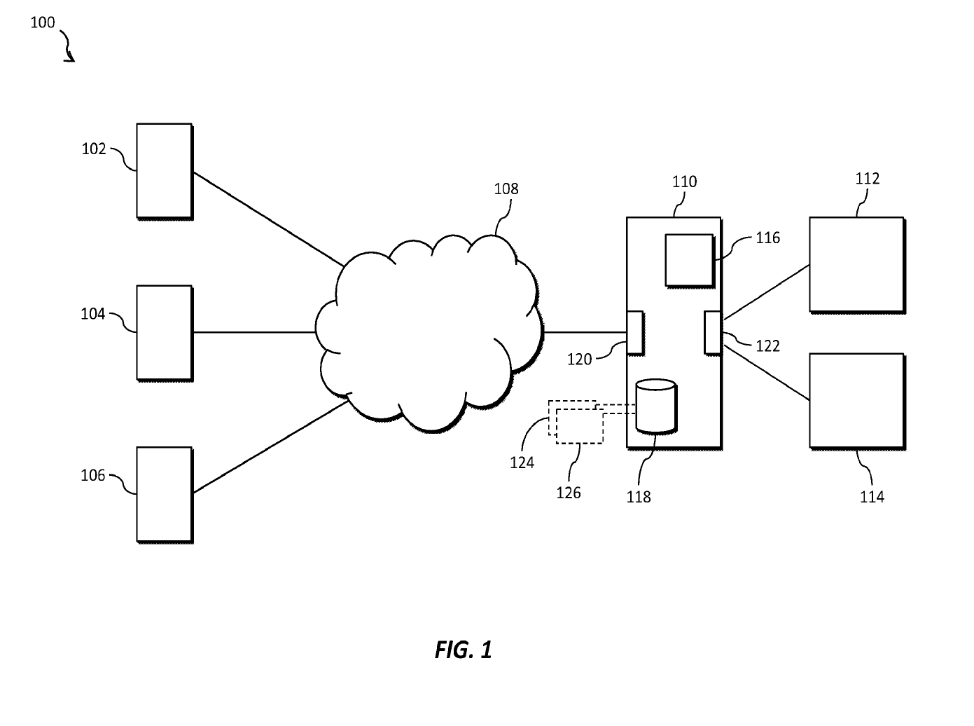

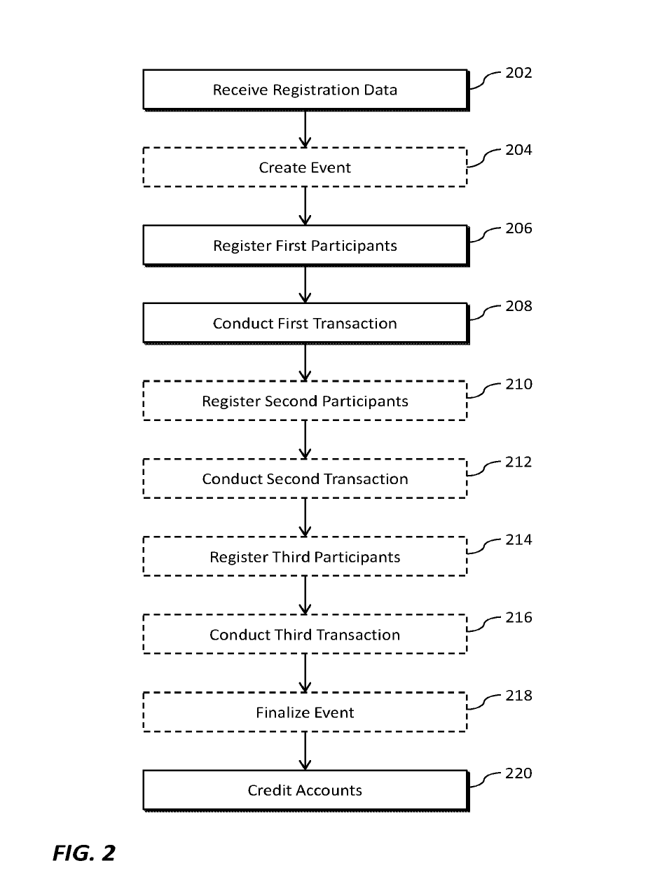

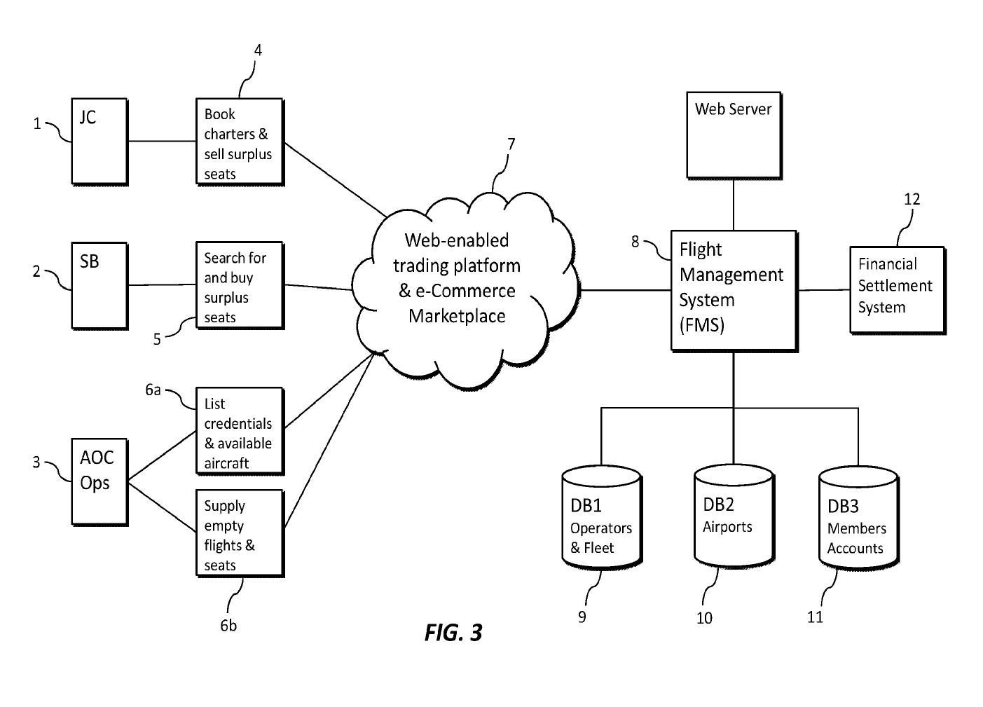

The description below will first contain a description of a generalized embodiment of a computerized system for reserving participants for a service made with reference to FIGS. 1 and 2. Following this, FIGS. 3 to 5 will contain a detailed description of an air charter booking service according to a specific embodiment.

FIG. 1 shows a generalized system 100 in which embodiments may be practiced. Within the system 100 are provided user equipment 102, 104 and 106. These user equipment may include computers, laptops, tablets, smartphones and/or phablets. The user equipment are connected via a network 108—for example the internet—to a server 110. The server 110 provides the reservation system as will be described below.

The server 110 may in turn be connected to an accounting system 112, and a third party service provider system 114. These connections may be local, as shown, or via the internet.

The server 110 may be a single unit, or distributed, i.e. in the cloud. For clarity, the server 110 will be referred to herein in the singular. The server contains a processing system 116, a memory 118 and one or more interfaces, shown as 120 and 122. The interface 120 is connected to the internet, and is thereby able to communicate with the user equipment 102, 104 and 106. The interface 122 is connected to the accounting system 112 and the third party service provider system 114. The memory stores computer readable instructions 124, and may also store data on participants, shown as 126.

A more detailed description of the use of the system 100 in an embodiment will be provided below. Nevertheless, in general, the processing system 116 of the server 110 retrieves and executes the computer readable instructions 124 from the memory 118. These computer readable instructions 124 cause the processor to perform steps as will be described below. In performing these steps, the processing system 116 may communicate, via a relevant interface 120 or 122, with the user equipment and/or the accounting system 112, and a third party service provider system 114. To communicate with the user equipment, the server 110 may present a website, with which a user of the user equipment may interact

A method describing the use of the system 100 according to an embodiment will now be described with reference to FIG. 2. In the following, the server 110 will be described as performing certain tasks. It will be apparent that this refers to the processing system 116 of the server 110 performing the steps in accordance with computer instructions 124.

As stated above, the system 100, and in particular the server 110, may be used to register participants for a service. This service may be provided via a plurality of events, where a variable number of participants are registerable with each event. Moreover, at least a first part of a cost of each event is independent of the number of registered participants associated with that event. To enable registration, the server 110 may be configured with a plurality of accounts to enable, at least, registering of, and payment for, participants associated with events. Data associated with each account may be stored in the memory 118.

In step 202, the server 110 receives registration data from one or more of the user equipment. As mentioned above, this registration data may be provided via a web interface hosted by the server 110.

The registration data may comprise, amongst other things, the parameters of an event. When the events are charter flights and each registered participant corresponds to a booked seat on a charter flight, the parameters may comprise at least one of: an identifier of an charter flight; a start location; a destination location; a time and date; a type of aircraft to be booked; and an identity of an aircraft charter company to be used for the charter flight.

In addition, the registration data may comprise data indicative of a first number of participants to be registered for the event in association with a first account, and data indicative of a second number of participants to be registered for the event. This second number may be associated with at least one second account. The registration data may further comprise third data indicative of a one or more third numbers of participants to be registered for the event in association with one or more third accounts. The relevance of this third data will be described in more detail below.

The registration data may be received as a plurality of messages received, for example, from different user equipment 102, 104 and 106. For example a first message—received from a first user equipment 102 and associated with a first account—may comprise the parameters of the event and the data indicative of the first number of participants. At least one second message—received from at least a second user equipment 104 and/or 106 and associated with at least one second account—may comprise the data indicative of the second number of participants. Equally one or more third messages may comprise data indicative of the one or more third numbers of participants to be registered for the event in association with the one or more third accounts.

Where the registration data is received in separate messages, the server 110 may perform certain of the steps below in response to receiving the messages. For example, the registering of the first number of participants and the conducting of the first transaction (steps 206 and 208) may be performed responsive to the first message. Equally, the registering of the second number of participants and the conducting of the second transaction (steps 210 and 212) may be performed responsive to the at least one second message. Finally, the registering participants for the event based on the third number and conducting a third transaction (steps 214 and 216) may be performed responsive to the at least one third message.

The server 110 may create an event in step 204. This event may be created prior to the receipt of any data in step 202. Alternatively, the event may be created responsive to the receipt of the one or more parameters of the event received in the registration data. These parameters may accordingly be used to create the event. In creating an event, the server 110 may communicate with the third party service provider system 114. This may involve providing the parameters to the third party system 114, and receiving information, such as quotes and information on availability back.

Having created an event, the server 110 may, in step 206, register participants for the event based on the first number. In the context of a flight booking system, this may involve chartering an aircraft for one or more flights (which may include one or more positioning flights). In addition, in step 208, the server 110 may conduct a first transaction in which the first account is debited by a first amount equal to a first value, the first value comprising the first part of the cost of the event. To debit the first account, the server 110 may communicate with the accounting system 112.

As stated above, the first part of the cost of the event is the part independent of the number of participants. In other words, the first part is the fixed cost of the event. In some cases, the first part of the cost of the event comprises the total cost of the event. However, in other cases, a second part of the cost of the event is dependent on the number of participants. As such, the first amount may include both the first part (the fixed cost) and any variable part calculated based on the number of participants, or may simply be the total, fixed, cost of the event.

It will therefore be apparent that, with the exception of the variable, per participant, costs of the event, the first account is debited for the full costs of the event. This ensures that the event can be created (which, when the service is a charter flight, involves chartering the aircraft), irrespective of whether any further participants register for that event. Nevertheless, as will be described in more detail below, the first account may subsequently be credited for at least some of this first amount.

Following step 208, and possibly in response to receipt of a second message as described above, the server 110 may, in step 210, register further participants for the event based on the second number. In so doing, the server 110 may, in step 212, conduct a second transaction in which the at least one second account is debited a second amount equal to a second value.

The second value may be calculated using the first and second numbers. In particular embodiments, the second value comprises a part which is calculated using the following formula:

F·N₂/(N₁+N₂) (1)

where F is the said first part of the cost of the event, N₁ is the first number, and N₂ is the second number. This means that the second amount may contain a portion of the fixed costs (F), proportionally assigned based on the number of participants registered by the second account compared to the total number of participants (N₁+N₂). In embodiments where there are costs per participant, the second value may also comprise a part calculated using the second amount and the cost per participant.

In this exemplary method, further participants may be registered. As such, the registration data may comprise data indicative of a one or more third numbers of participants to be registered for the event in association with one or more third accounts. Therefore, in step 214, the server 110 may register participants for the event based on the one or more third numbers. In addition, in step 216, the server 110 may conduct one or more third transactions in which the one or more third accounts are debited amounts equal to respective one or more third values. In such cases, the 10 second value and the one or more third values may comprises a part which is calculated using the formula:

F·N_{X}/N_{C} (2)

where F is the said first part of the cost of the event, N_{X} is the number of participants registered in association with a given account ‘X’ and N_{C} is the total number of participants registered for the event when the registration is performed including N_{X}.

An optional finalizing process for the event may also be performed by the server 110 in step 218. After this finalizing process further participants cannot be registered for the event. This step may be followed by step 220 in which crediting of accounts is performed. By using the finalizing process, it can be ensured that any credits only need be applied once, simplifying the process (as the makeup of the registered participants for an event cannot change after the finalizing process).

In step 220, the server 110 may credit the accounts if and as required. In particular the server 110 may credit the first account with at least some of the second amount. As a third number of participants have registered, the server 110 may also credit the first account with at least some of the third amount, and credit the at least one second account with at least some of the third amount.

The at least one second account may be credited with a value calculated using the formula:

F·N₂[1/N_{T}−1/N_{C}] (3)

where F is the said first part of the cost of the event, N₂ is the number of participants registered in association with the second account, N_{C} is the total number of participants registered for the event when the registration was performed for the second account including N₁ (i.e. N₁+N₂), and NT is the total number of participants registered for the event when all registrations are taken into account. In other words the at least one second account is credited such that a value of the difference between the amount debited from, and the amount credited to, the at least one second account comprises a part given by the formula:

F·N₂/N_{T} (4)

where F is the said first part of the cost of the event, N₂ is the number of participants registered in association with the second account, and NT is the total number of participants registered for the event when all registrations are taken into account.

The first account may be credited by a predetermined fraction of the second amount. Where a third amount has been debited, the first account may be credited by a predetermined fraction of the debits from the first and second accounts, taking into account any subsequent credits to these accounts, as described above for a second account. The predetermined fraction may be between 50% and 100%, and may be adjusted to reflect that the first account was able to define the parameters of the service. For example, the first account may be credited by a value comprising a part calculated using the formula:

pF·(N_{T}−N₁)/N_{T} (5)

where p is a predetermined fraction, F is the said first part of the cost of the event, N₁ is the number of participants registered in association with the first account, and N_{T} is the total number of participants registered for the event when all registrations are taken into account.

The above system means that any account holder that has registered for the service pays what might be termed a current cost when registering for the service, but may subsequently receive credit as and when further participants register for the service.

The amounts debited and credited will now be described in more detail. In this example, the first part of the cost (the fixed cost) will be given the symbol F, the variable part the symbol V, the numbers of participants associated with each account N₁, N₂ and N₃ for the first, second and third accounts respectively. Finally, the symbol p will be used for the predetermined fraction described above.

The first account is debited:

F+N₁·V (6)

The second account is debited:

F·N₂/(N₁+N₂)+N₂·V (7)

The third account is debited:

F·N₃/(N₁+N₂+N₃)+N₃·V (8)

The first account is credited:

pF·(N₂+N₃)/(N₁+N₂+N₃) (9)

The second account is credited:

F·[N₂/(N₁+N₂)−N₂/(N₁+N₂+N₃)] (10)

The third account receives no credit. As such the total paid by each account (i.e. after debits and credits are taken into account) may be given by the following:

The first account pays:

F+N₁·V|pF·(N₂+N₃)/(N₁+N₂+N₃) (11)

The second account pays:

F·N₂/(N₁+N₂+N₃)+N₂·V (12)

The third account is debited:

F·N₃/(N₁+N₂+N₃)+N₃·V (13)

As it can be seen, the first account is partially credited for the extra participants for the service. Meanwhile, the second and third accounts pay the same cost per participant. It will be appreciated that where the predetermined fraction p is 100%, the first, second and third account all pay the same proportional amount. It will further be appreciated that the variable cost V may be zero.

While the above example describes effectively three sets of participants, embodiments work with any number of independently registering participants and thus accounts. In general, where NT is the total number of participants when the event is finalized, N_{X} is the number of participants registered for that given registration associated with account ‘X’ (i.e. the second, third etc. number above), and N_{C} is the current total number of participants registered for the event when the registration is performed including N_{X}, the following applies:

The first account will be debited:

F+N₁·V (14)

The first account is credited:

pF·(N_{T}−N₁)/N_{T} (15)

The first account pays:

F+N₁·V−pF·(N_{T}+N₁)/N_{T} (16)

Further accounts are debited:

F·N_{X}/N_{C}+N_{X}·V (17)

Further accounts are credited:

F·N_{X}[1/N_{T}−1/N_{C}] (18)

Further accounts pay:

F·N_{X}/N_{T}+N_{X}·V (19)

While the above concentrates on a particular system for calculating amounts to credit and debit—a method which may be termed “FareShare”—other methods may be used. For example the second and third accounts may pay a fixed price per registered participant. In this case only the first account may be credited, in this case by a predetermined fraction of the total revenue gained through the additional registrations.

To facilitate the operation of the system, the debited amounts are stored in a further account from which the credited amounts are taken. The server 110 may transfer at least some of the first amount to an account of a provider of the event (i.e. the operator of system 114) from the further account. Where amounts are described as being debited or credited, this may be conducted by the server 110 communicating with the accounting system 112.

In some embodiments, the method described above may be augmented by enabling the server 110 to receive a search request. The search request may comprise one or more parameters of a desired event. Responsive to the search request, the server may send a message comprising at least one identity of an event for which participants are registerable. In other words, the server 110 may identify existing events, that is events created in step 204, to a user equipment.

In further embodiments, the server 110 may receive further data comprising data indicative of a further number of participants to be registered for the an event in association with a further account. This further data may also comprise data indicative of a minimum number of participants which are to be registered for the event before the further participants are to be registered. As described above, the number of participants has an effect on the amount which is payable per participant. As such the further data may be a conditional registration request, conditional based on the cost per participant being below a certain point. As such, it will be appreciated that the data indicative of a minimum number of participants may alternatively describe a maximum amount (total or per participant) which will be paid to secure the booking.

Responsive to this further data, the server 110 may monitor the number of participants registered for the event and when the number of participants registered for the event is equal to or greater than the minimum number of participants, the server 110 may send a message to the further account. Alternatively, the server may automatically register participants for the event based on the further number and conduct a further transaction in which the further account is debited a further amount. In other words, it is possible to send a conditional request which, if fulfilled, will result in an alert or an automatic reservation of the participants.

It will be appreciated that the events described herein can be linked to many types of service. While air charters have been mentioned, any form, or combination of forms, of transport (i.e. limousines) can be registered for in this way. Moreover, in the context of air travel, a single event may include an outward and return leg, and/or a so-called positioning flight, where a charter aircraft flies to or from its base of operations to or from a source or destination point. Furthermore, the events may not include travel at all and, for example the above may be used for a booking of a room, such as for a private screening in a cinema.

Furthermore, it will be understood that while the accounts described above may be used for repeated registrations, an account may alternatively be a temporary account created for a single reservation.

In some embodiments, the event may be created in response to a first account providing registration data containing parameters of an event. Nevertheless, in other embodiments, an event may be created by other methods, for example a service provider may create an event, and participants may register to this existing event. In such situations, all participants and the related accounts may be charged the FareShare price at the time of booking, given by equation 17 above and, if further participants register, may receive a credit as given by equation 18.

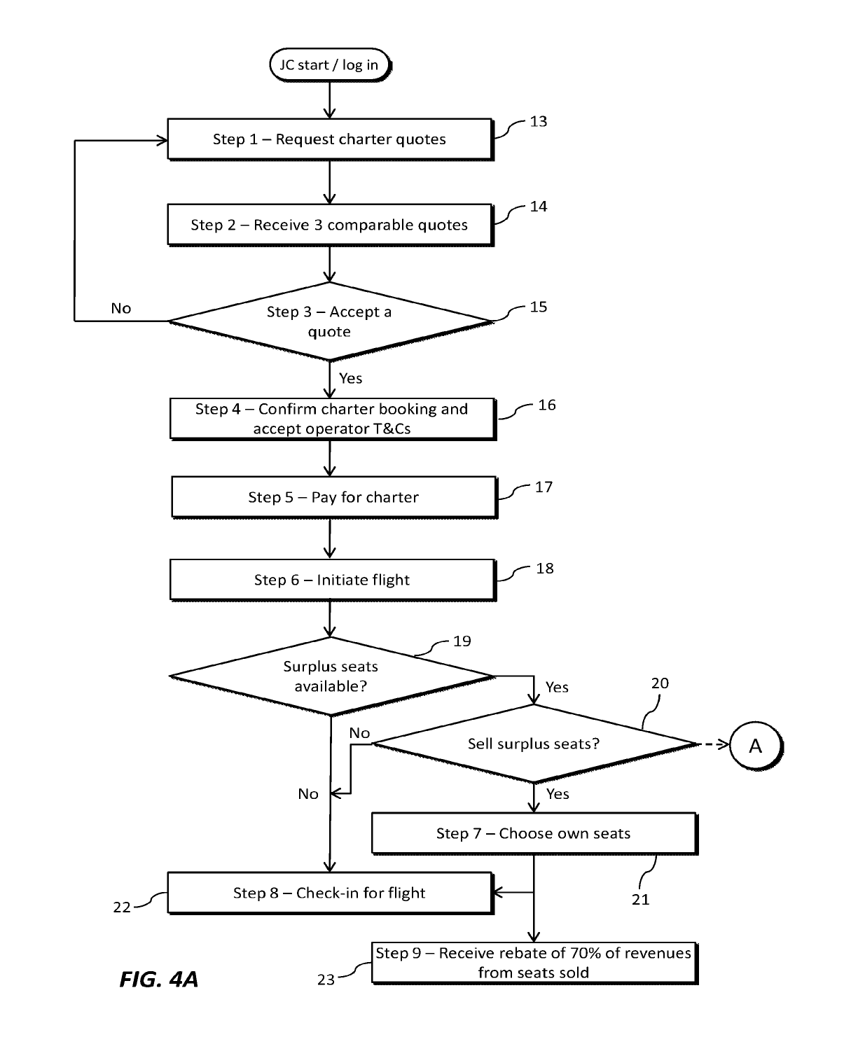

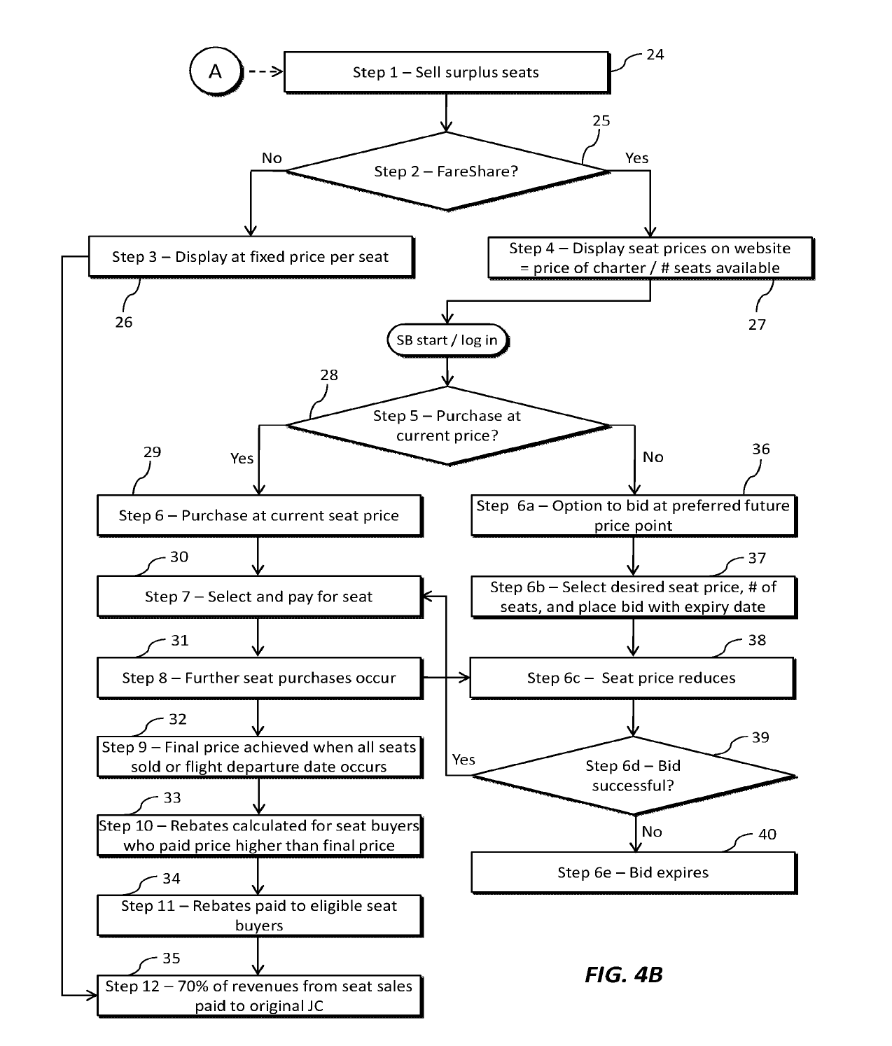

A description of a computing system providing a flight booking system in which embodiments may be practiced will now be described with reference to FIGS. 3, 4A and 4B. As shown in FIG. 3, a distributed computer network air travel booking system may serve to connect three web-enabled trading systems, or portals 4, 5, 6a, 6b, together into one e-commerce marketplace 7. Each portal provides a means of trading between two different segments of air travelers 1, 2 and a network of participating aircraft operating companies 3.

A first segment of air travelers 1, i.e. holders of the above mentioned first accounts, may be known as ‘jet charterers’, or hereinafter referred to as IC′, and are those types of air travelers who wish to charter a whole aircraft from an aircraft operating company 3 holding a valid aircraft operator certificate (AOC) for the purposes of public carriage. Such types of air travelers already exist in significant numbers and most typically use unsophisticated methods of booking a charter with an aircraft operator such as through an intermediary broker or over a voice telephone link.

The second segment of air travelers are air travelers who desire to book one or more individual seats on a private aircraft flight and are known as seat buyers 2, hereinafter referred to as ‘SB’, these may be considered the holders of the second and third accounts mentioned above.

A portal may be provided through the means of a website for the JC, or first account holder, to search for an available aircraft to charter, request comparable price quotations, and book and pay for an aircraft charter 4 from a participating operator 3 and the SB, or second account holders, to search for, book and pay for one or more individual seats 5 on flights created by the JC.

Participating operators 3 may be provided with a directory service 6a listing the aircraft available for charter in their fleet, as well as their company credentials, and in addition the means with which to advertise any flights 6b that they are scheduled to operate, such as positioning flights, that have seats available for sale as a means of securing incremental revenues for flights that would otherwise have operated with no passengers.

A web-enabled trading platform 7 may be provided in which each of these three entities can trade in an e-commerce marketplace. JC 1 can use the website portal 4 to search for and charter aircraft online; SB 2 can use the website portal 5 to search for and purchase available seats on flights listed on the trading platform by JC and operators; and operators can use the portal to list their aircraft available for charter 6a and advertise any flights on which they wish to sell seats 6b.

The website portals 4, 5 may provide JC and SB customers with access to a booking engine in the trading platforms Flight Management System, hereinafter referred to as ‘FMS’, located on a server 8. The FMS utilizes three databases 9, 10, 11 to enable the JC and SB customers to communicate their desired travel itinerary (departure airport, arrival airport, date, time of departure, number of people in their party), search for available aircraft, flights and seats that match their itinerary request, and book and pay for flights and seats.

The first database 9, DB1, may store and manage data about each operator contracted to advertise their fleet of aircraft and services to JC and SB air travelers. This data may include all the information air travelers need to make an informed decision about whether they wish to book an aircraft operated by the operating company, such as the operators contact details and website, their aircraft operations certificate issued by the relevant regulatory authority, their terms and conditions of carriage, each aircraft in their fleet with type and designation details, visual information on each aircraft and copies of their insurance certificates.

The second database 10, DB2, may provide a directory listing of airports available for air travelers to fly from and to within a defined geographical area. The data held on this database includes airport designation codes, location, opening times and providers of ground handling services.

The third database 11, DB3, may store and administer all information related to individual air travelers who have created accounts on the trading platform website as potential users of the system (or ‘members’). During the account creation process individuals record their name, contact details including e-mail address, and a profile of their travel needs and intentions. In addition to the account information, air travelers may achieve approved status in an online community of members based on a set of rules, terms and conditions that govern how members can access and utilize the community trading platform to book an aircraft charter, or share chartered aircraft with other members who have created accounts. This community approach may follow the model and methods of a social media community.

The data collected from members when an account is created may be used to store a member account in the FMS, which subsequently provides a means of identification, log in capability and access to the functions and benefits of the trading platform. In addition the necessary legal terms and conditions on which commercial transactions can be made using the booking platform and method of embodiments, may be agreed by a new member during the account creation process and provide the legal basis on which transactions can be made.

Databases DB1, DB2 and DB3 9, 10, 11 may feed relevant data via a communications link to the booking engine in the server-based FMS 8 to enable transactions to take place. Air travelers initiating such transactions may complete a booking of a whole-aircraft charter or a purchase of individual seats on such flights through the booking engine in the FMS 8 and may confirm their booking by paying online. The payment of such bookings may be processed through a financial settlement system 12 which enables the member to pay by credit card through an externally contracted payment platform or to initiate a bank transfer of funds.

The AOC ops 3 may be considered analogous to the third party service provider system 114 described above. Equally the financial settlement system 12 may be considered analogous to the accounting system 112 above. Some or all of the webserver, flight management system 8 and databases 9, 10 and 11 may be incorporated into the server 110 described above.

A method by which JC members may charter a whole aircraft from an aircraft operator is illustrated in FIG. 4A by means of a flowchart. A JC member wishing to charter an aircraft may first gain access to the booking engine through the website by logging in, thereby establishing a computer to computer internet connection. An e-mail address and password may be matched to those held in database DB3 11 to validate that the member has an account and authorized to access and utilize the platform.

Once granted access to the platform JC members may request quotations 13 from a selection of operators listed in the directory held in database DB1 9. At this stage in the process JC members may be required to enter details of their preferred itinerary into a request form on a web page, including airport of departure, airport of arrival, date of travel, time of departure and number of seats required. There may also be the option to enter the same information for a return flight or designate the trip as a one way flight.

At this stage JC members also may indicate any preference for a particular size of aircraft based on the number of seats in the aircraft cabin. The FMS may then calculate and display through the website indicative costs for this trip so that members are informed as to the likely price range for their trip for the whole aircraft and on a per seat basis. The latter estimation may be based on the average seat price on their chosen route calculated from previous transactions utilizing data stored in database DB3 11.

JC members also have the option to direct their quotation request to operators listed in the directory held in database DB1 9 for whom they have a preference. Such a preference may for example be based on previous good experience of an operator or a particular preference for a certain type of aircraft or cabin layout.

Once all required data has been entered by the JC member the request may be recorded in the FMS 8. A selection of relevant participating aircraft operators who are listed in the directory may be communicated with using a communications link via which quotations for the trip may be requested. Such a communications link may be a computer-to-computer link over the internet.

By means of the chosen communications a range of price quotations may be received along with details of the aircraft and routing information from the operators. Some or all of the quotations may be uploaded into the FMS 8 which automatically communicates each selected quotation to the JC member who made the quotation request. This may be via of e-mail communication 14. In addition all quotations generated may be displayed in the member's own individual account administered through database DB3 11 and accessible through their website log in. Each quotation may include details of the operator and the aircraft on which the quotation is based, in addition to the gross price of the charter. Each quotation may also be assigned a period of validity, at the end of which timescale the quote will automatically expire in the FMS.

The JC member may inspect and compare the quotations received, and may subsequently accept one of the quotations 15. If they choose not to accept any of the quotations these will automatically expire at the predetermined time. The JC member may then have the option of starting again at Step 2 13 with a new quotation request or abandoning their search.

If the JC member accepts a quotation 16 by means of the website, they then create a new booking in the FMS. This may include accepting an indication on the confirmation web page that they agree to and accept the operator's terms and conditions of carriage, thereby forming a legal contract between themselves and the aircraft operator. As the booking has been made under the conditions of the member terms and conditions of the trading platform then they may also be legally contracted under those terms with the company owning and administering embodiments acting as an agent in the transaction.

Once terms and conditions are accepted, the JC member may then be presented with a secure web-enabled payment page 17. JC members may elect to pay by credit card using a link to an externally provided credit card payment settlement platform, or pay by direct bank transfer by following the instructions listed on the payment web page. Once funds are cleared in the bank account of the company administering the trading platform acting as an agent, then the operations team may initiate a communication through the administrative console of the FMS to the JC member by the means of e-mail that payment has been received and they can proceed to Step 6.

The JC member, i.e. the first account holder, may thereby provide suitable registration data to the system to create an event, in this case a flight. The information used to obtain the quote; that is the airport of departure, airport of arrival, date of travel, time of departure and number of seats required, form the parameters used to register for and create the event.

In Step 6 18 the JC member may be required to initiate their flight. At this stage the platform gives the JC member the option of selling any surplus seats they may now have purchased 19. Surplus seats are defined as those that the JC member has purchased on either the flight they will occupy and any associated positioning flight that they may have also paid the operator to operate. For example, if a JC member books a 6 seat aircraft for a flight from New York, N.Y. to Cleveland, Ohio it is likely that they will in fact have paid for two flights. The flight from New York to Cleveland which they occupy, and an additional positioning flight which then returns the aircraft back to base from Cleveland to New York. This is commonly known as an ‘empty leg’. The charter price has included payment for the operating costs of the empty leg and under the terms of the contract of the transaction, conducted through the method of embodiments, the seats on that positioning flight also belong to the JC member who booked it.

As such, it is apparent that an event may include a single flight, or a flight and the return ‘positioning flight’. Equally a return trip may be considered a single event, or the two legs may be handled as separate events.

Using this example, if the JC member's party consists of four people including themselves, then they have a total of eight surplus seats: two on the outbound flight and six on the returning positioning flight. Using the method of embodiments the JC member can decide to make all of the surplus seats available for sale to other user members 20, the SB members 2, in the e-commerce marketplace 7, or limit the sale to those on the positioning flight in order to keep the cabin in which the JC member's party is flying to themselves.

If the JC member decides not to sell any of their surplus seats, or does not have any surplus seats to sell, then they can indicate 20 that they reserve all the seats on their flight for their own use. For example, this may occur if their party size means that all available seats will be occupied, or that it is a one-way charter flight and there is no associated positioning flight on which to sell seats.

If the JC member makes any surplus seats available for sale then at this stage in the method the flight may be displayed on the trading platform website with the number of seats and the price per seat advertised to other users and to any visitors to the website. The method for pricing and purchasing seats is illustrated in FIG. 4B by means of a flowchart.

Once the decision is made on whether to make any surplus seats available for sale the JC member may choose the seats they wish to occupy from a floorplan diagram of the specific aircraft they have booked 21. Once reserved on the website page the seats are recorded in the FMS as reserved and therefore unavailable for selection by any SB members who then subsequently book seats on that same flight.

The final step in the method may be for the JC member to check-in for their flight 22 and provide the names and any required identification information of all the people travelling on the flight. This information may be recorded in the FMS and a passenger manifest created which is then sent by e-mail to the operator by for filing with the flight plan.

If any seats are sold on the platform to SB members, then, for example, 70% of the revenue generated may be rebated to the original JC member who booked the charter flight 23, creating a shared economic interest in successful sale of surplus seats between the JC member and the trading platform owner of embodiments. Here the 70% represents the predetermined fraction discussed above in Equations 5, 9, 11, 15 and 16.

At the point that surplus seats are made available for sale 20 a decision must be made as to whether they will be sold under the a variable pricing plan called ‘FareShare’, or whether to sell them on a fixed price basis 25 where the price is held constant. Factors influencing the decision may include levels of visible demand for seats on the specific route at the date for which the flight is schedule to operate; previous experience of demand for seats on this route and the average price achieved; preference of the JC member for a quick sale or a willingness to try and achieve best price possible.

If the decision is made to advertise seats for sale at a fixed price the price may be decided by JC member who made the seats available for sale and advertised at that price only 26. The revenues generated from any seats sold may then be shared with the JC member by the platform administrator and owner of embodiments with the JC member receiving a rebate equivalent to, for example, 70% of such revenues once the flight is completed 35.

If the decision is made to sell the seats under the ‘FareShare’ variable pricing plan then the seats may be advertised at a range of possible price points based on the price of the original charter, divided by the number of seats available for sale, and all possible price points in between based on the price of a seat at each possible load factor on the flight 27. Formulae describing the FareShare system are provided above, namely equations 1 to 19.

Nevertheless, as an example, if the original flight charter price paid (i.e. the first part of the cost of the event described above) by the JC member is $12,000, and the JC (first account holder) has reserved two seats for their own party, then the first SB member (i.e. the second account holder) may buy a single seat at $4,000, this being the original charter price divided by the current load factor of 3 passengers on the flight. If a second SB member (i.e. a third account holder) now joins the flight as the fourth passenger, then the seat price for all passengers will now reduce to $3,000. As a consequence, the first SB member who booked seat will be eligible for a credit or rebate of $1,000. These credits or rebates may be performed once the flight has been completed, as the final seat price cannot be calculated until the flight has closed for sale immediately prior to departure.

Each time a seat sells on a flight the price therefore reduces in line with the increased load factor on that flight. The details of this reduction are described in more detail above, in particular in equations 7, 8 and 17. The website of the trading platform may advertise the flight with the current seat price and the lowest possible price displayed. It may also displays all possible price points in between so that all potential SB members can see what the existing and possible future price per seat will be, and then make their own buying decisions accordingly.

A SB member who searches for a seat and finds a good match for their itinerary therefore has the option of whether to purchase a seat at the current price as displayed on the platform website, or wait to see if the price reduces further as other SB members purchase seats 28. The potential SB must weigh however the benefit of buying a seat at the current price to secure it, and thereby reducing the cost for all on the flight, or waiting until a lower price is reached.

If the SB member elects to purchase a seat at the current price at Step 6 29 they may choose a specific seat, or seats if more than one is being purchased, on the floorplan displayed for the aircraft on the website, with only unreserved seats available for selection, and then proceed to the payment page to pay for their chosen seat at the current price 30.

If other SB members join the same flight by purchasing further seats, this action then leads to a reduction in the price of the seats for all passengers on the aircraft 31. The final seat price is achieved when one of the following events occur: all seats have sold or the flight closes for sale at least an hour prior to departure on the day of departure 32, and preferably 3 to 6 hours.

Once a flight has been completed credits or rebates are calculated for all those SB members (second and third account holders) who purchased seats and were passengers on the completed flight 33. The rebate paid to such SB members is the difference between the price they paid for their seat, i.e. the amount they were originally debited, and the final seat price, i.e. the cost calculated when all reservations are taken into account. Rebates/credits may be paid out to those eligible for a rebate within 14 days of the flight completion 34.

Revenues generated from the sale of seats to the SB members are summed up and 70% of this total sum may then be rebated to original JC member who chartered the aircraft and made their surplus seats available for sale 35, thereby reducing the cost of their charter. In other words, the original JC member or first account holder may receive a predetermined fraction of the revenue generated by the sale of seats.

If an SB member at Step 5 28 does not wish to purchase at the current displayed seat price they may also have the option of bidding for a seat at a future price they prefer 36. The website may displays all possible price points for seats on the flight enabling a SB member to determine a price at which they would buy a seat, or seats, should that price point be achieved as seats are sold and the load factor increases.

Such a SB member's bid may be entered by selecting the price point the member desires, the number of seats they wish to bid for, and a date and time at which their bid will expire 37. As mentioned above, the current seat price is equivalent to a minimum number of reservations (seats booked). Either may be used to define the threshold. The bid may be placed online through the web page and logged in the FMS. At the point the bid price is reached through the ‘FareShare’ variable pricing calculations described in the method 38, the bid may automatically be accepted by the FMS and the seat or seats allocated to that SB member 39. They may be requested to select their seats and pay as at Step 7 30 and the method continues at that point as previously described in the method.

If the bid is not successful at Step 6d 39 then it may automatically expire on the date and time set by the SB member who placed the bid at Step 6b 37.

Therefore, in summary, this example describes a method of chartering an aircraft by an individual air traveler from an aircraft operator participating in a network of operators contracted to supply air charter services through an e-commerce marketplace accessible by means of a web-enabled portal and trading platform hosted on a server. This involves one or more of the following steps:
searching by an individual through a website portal for an available aircraft for charter to match a specific request for an air travel itinerary
specifying by the individual an itinerary consisting of departure airport, arrival airport date of departure, time of departure and number of people travelling in the same party
display of a list of participating operators including company identity, contact details, regulatory certification, terms and conditions of carriage, and aircraft in their fleet available for charter
display of each individual aircraft available through participating operators including aircraft type, tail number, date of manufacture, visuals of exterior and interior, floorplan and cabin dimensions, and insurance certification
responding to requests by individuals for a price quotation and assignment of a suitable aircraft to meet a specific itinerary request from amongst the pool of available aircraft supplied by the network of participating aircraft operators
posting by means of e-mail and display in a unique customer account assigned to an individual of a number of comparable quotations from participating operators including gross price of the charter, details of route and flight time, and specifications of the aircraft assigned by the operator to the requested itinerary
enabling the individual who requested the charter quotation to accept one of the quotations posted and confirm a booking of the aircraft as specified, agreeing to the operators terms and conditions and thereby forming a legally binding contract, and payment for the charter through a computer-enabled automated payment system

The searching may include:
creating an account through the website of the e-commerce trading platform an individual air travelers identity, contact information and travel preferences, including the specification of routes that the individual has a preference for travelling to enable the creation of a travel profile of the individual
identification of the member during the account creation process of their motivation for creating an account as either a potential charterer of aircraft, or a potential purchaser of individual seats on a private aircraft flight, or both
creation of a membership account to store the individuals data, facilitate communication by e-mail and other means with the member on a regular basis by the trading platform administrator to ensure the individual member remains informed of flight and seat availability
access by means of a personal and password protected web page of the member's individual account to facilitate the updating of their profile information including route preferences and months and dates in which they are interested in travelling on those routes
indication of specific dates the individual member is interested in receiving notification by e-mail of the availability of flights and seats on a preferred route and date that may become available from time to time

When an individual completes a booking, the following may be performed:
determining that there are surplus seats unoccupied by the individual or members of their party on a particular flight
enabling the individual to make any surplus seats available for sale to other individuals who have created an account on the website by means of a computerized initiation procedure during the flight confirmation process
specifying, by the individual who has surplus seats to sell, on which to flights they wish to sell seats, and further which seats they and members of their party wish to occupy, thereby specifying the unoccupied seats on all flights they have chartered available for sale
determination by the individual who has surplus seats to sell, whether the seats will be sold at a fixed price per seat agreed with the administrator of the trading platform, or whether they will be sold under the FareShare system described above whereby the price of a seat reduced as the number of the seats sold on a flight increases ensuring that all passengers share the cost of the flight equally
posting notice of the availability of seats on the individual's confirmed charter flight on the trading platforms website and by means of e-mail notification to other users with a known interest in the route on which the charter flight is taking place

The surplus seats made available for sale may then be booked and purchased by individuals who are users of the trading platforms website and have accepted the terms and conditions of membership that govern the responsibilities and liabilities of sharing a private jet flight.

This may be done by the individual:
searching for available seats to match a specified itinerary on flights posted by individuals who have chartered aircraft by means of the website portal to the trading platform
searching for available seats to match a specified itinerary on flights posted by participating operators who have unoccupied positioning flights with seats available for sale by means of the website portal to the trading platform
reserving and paying for individual seats on flights posted on the website portal under either a fixed price per seat pricing plan or a variable pricing plan whereby the price reduces in line with the number of seats sold
displaying on the website portal the possible prices per seat made available for sale under the variable pricing plan on a specific flight so that individuals can identify the seat prices that may be available in the future depending on the number of seats that may be sold
enabling individuals who are users to place a binding bid by means of the website for any number of the available seats on a specific flight at a price they are willing to pay should the price of the seats become available at that price
allocating seats automatically to the individual who placed a bid for a seat, or seats, at a specific price at the same time that the seats become available at that price due to preceding sales increasing the load factor on that flight

To reserve seats the following may be performed:
calculating after a flight on which surplus seats have been sold under the variable pricing plan has been completed, the final price of a seat on that flight under the method of the variable pricing plan
rebating to all purchasers of seats on that flight the difference between the amount of money they paid for their seat or seats and the final price of a seat on that specific flight, where such a difference exists

Finally, upon finalization of the flight, the following may be performed:
calculating after a flight on which surplus seats have been made available for sale has been completed, the amount of revenue collected by the administrator of the trading platform from the sale of seats by means of the website of the trading platform
rebating to the individual who booked and paid for the charter flight by means of the website of the trading platform, 70% of the value of the total revenues received from the sale of seats (excluding any rebates or credits to SBs) on their flight under either the fixed or variable pricing plans.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims. The features of the claims may be combined in combinations other than those specified in the claims.

What is claimed is:

1. A computerized system for registering participants for a service provided via one or more events, wherein a variable number of participants are registerable with each of the one or more events, and wherein at least a first part of a cost of each of the one or more events is independent of the number of registered participants associated with that event,
wherein the computerized system is configured with a plurality of accounts to enable registering of, and payment for, participants in the one or more events, and
wherein the computerized system comprises at least one processing system and at least one memory, wherein the at least one memory comprises computer readable instructions which, when executed by the at least one processing system, cause the computerized system to perform a method comprising:
receiving registration data comprising one or more parameters of a first event of the one or more events, the registration data comprising first data indicative of a first number (N₁) of participants to be registered for the first event in association with a first account;
registering said first number (N₁) of participants for the first event;
conducting a first transaction in which the first account is debited by a first amount equal to a first value (F), the first value (F) comprising the first part of the cost of the first event;
calculating a plurality of condition values indicative of a varying cost per participant, each condition value comprising a part which is calculated using the formula:
F/N
where, for each of the condition values, N is a number greater than N₁ and less than or equal to a maximum number of participants for the first event;
making the plurality of condition values available via an online interface to one or more further participants;
receiving second data indicative of a second number (N₂) of participants to be conditionally registered for the first event, the second data being associated with at least one second account, and comprising a selected one of the condition values;
monitoring the number of participants registered for the first event;
receiving third data indicative of a third number (N₃) of participants to be registered for the first event, the third data being associated with at least one third account;
registering said third number (N₃) of participants for the first event;
automatically registering the second number (N₂) of participants for the first event in dependence on said selected condition value being greater than or equal to a value calculated by the formula:
F/(N₁+N₂+N₃)
conducting a second transaction in which the at least one second account is debited by a second amount equal to a second value, the second value comprising a part which is calculated using the following formula:
F·N₂/(N₁+N₂+N₃); and
conducting a further transaction in which the first account is credited by a further amount in dependence on registration of said second and third number of participants for the first event.

2. The computerized system of claim 1, wherein the one or more events are charter flights and each registered participant corresponds to an individual who has booked a seat on a charter flight.

3. The computerized system of claim 2, wherein the one or more parameters comprise at least one of:
an identifier of an charter flight;
a start location;
a destination location;
a time and date;
a type of aircraft to be booked; and
an identity of an aircraft charter company to be used for the charter flight.

4. The computerized system of claim 1, wherein the method comprises creating the first event using the one or more parameters received in the registration data.

5. The computerized system of claim 1, wherein:
the registration data comprises a first message associated with the first account, the first message comprising the one or more parameters and the first data; and
the registering of said first number of participants and the conducting of the first transaction are performed responsive to the first message.

6. The computerized system of claim 1, wherein the method further comprises:
conducting one or more third transactions in which the one or more third accounts are debited amounts equal to respective one or more third values.

7. The computerized system of claim 6, wherein the one or more third values comprises a part which is calculated using the formula:
F·N_{X}/N_{C}
where F is the said first part of the cost of the first event, N_{X} is a number of participants registered in association with a given third account ‘X’ and N_{C} is a total number of participants registered for the first event when the registering of participants for the first event based on the one or more third numbers is performed including N_{X}.

8. The computerized system of claim 6, comprising crediting the first account with a value comprising at least some of the third value.

9. The computerized system of claim 8, wherein the at least one third account is credited with a value calculated using the formula:
F·N₃[1/N_{T}−1/N_{C}]
where F is the said first part of the cost of the first event, N₃ is said third number, N_{C} is the total number of participants registered for the first event when the registration was performed for the second account including the first number, and N_{T} is the total number of participants registered for the first event when all registrations are taken into account.

10. The computerized system of claim 1, wherein the method comprises conducting a finalizing process for the first event after which further participants cannot be registered for the first event, and wherein the crediting is performed after the finalizing process.

11. The computerized system of claim 1, wherein the first account is credited by a value comprising a part calculated using the formula:
pF·(N_{T}−N₁)/N_{T}
where p is a predetermined fraction, F is the said first part of the cost of the first event, N₁ is the first number, and N_{T} is a total number of participants registered for the first event when all registrations are taken into account.

12. The computerized system of claim 1, wherein any debited amounts are stored in a further account from which the credited amounts are taken.

13. The computerized system of claim 1, wherein the method comprises:
receiving a search request, the search request comprising one or more parameters of a desired first event; and
responsive to the search request, sending a message comprising at least one identity of an first event for which participants are registerable.

14. The computerized system of claim 1, wherein the method comprises:
receiving further data indicative of a further number of participants to be registered for the first event in association with a further account, and data indicative of a minimum number of participants; and
monitoring a number of participants registered for the first event; and
responsive to the number of participants registered for the first event being equal to or greater than the minimum number of participants, sending a message to the further account.

15. The computerized system of claim 1, wherein the method comprises:
receiving further data indicative of a further number of participants to be registered for the first event in association with a further account, and data indicative of a minimum number of participants; and
monitoring a number of participants registered for the first event; and
responsive to the number of participants registered for the first event being equal to or greater than the minimum number of participants:
registering participants for the first event based on the further number;
conducting a yet further transaction in which the further account is debited a further amount.

16. A computer program product comprising a non-transitory computer-readable storage medium having computer readable instructions stored thereon, the computer readable instructions being executable by a computerized system to cause the computerized system to perform a method for registering participants for a service provided as one or more events, wherein a variable number of participants are registerable with each of the one or more events, at least a first part of a cost of each of the one or more events is independent of the number of registered participants associated with that event, the computerized system is configured with a plurality of accounts to enable registering of, and payment for, participants in the one or more events, and the method comprises:
receiving registration data comprising one or more parameters of a first event of the one or more events, the registration data comprising first data indicative of a first number (N₁) of participants to be registered for the first event in association with a first account;
registering said first number (N₁) of participants for the first event;
conducting a first transaction in which the first account is debited by a first amount equal to a first value (F), the first value (F) comprising the first part of the cost of the first event;
calculating a plurality of condition values indicative of a varying cost per participant, each condition value comprising a part which is calculated using the formula:
F/N
where, for each of the condition values, N is a number greater than N₁ and less than or equal to a maximum number of participants for the first event;
making the plurality of condition values available via an online interface to one or more further participants;
receiving second data indicative of a second number (N₂) of participants to be conditionally registered for the first event, the second data being associated with at least one second account, and comprising a selected one of the condition values;
monitoring the number of participants registered for the first event;
receiving third data indicative of a third number (N₃) of participants to be registered for the first event, the third data being associated with at least one third account;
registering said third number (N₃) of participants for the first event;
automatically registering the second number (N₂) of participants for the first event in dependence on said selected condition value being greater than or equal to a value calculated by the formula:
F/(N₁+N₂+N₃)
conducting a second transaction in which the at least one second account is debited by a second amount equal to a second value, the second value comprising a part which is calculated using the following formula:
F·N₂/(N₁+N₂+N₃); and
conducting a further transaction in which the first account is credited by a further amount in dependence on registration of said second and third number of participants for the first event.
